(19) United States
(12) Patent Application Publication
(10) Pub. No.: US 2015/0199808 A1
(43) Pub. Date: Jul. 16, 2015

(54) DEGREE-OF-DISPERSION INSPECTING APPARATUS FOR PARTICLES OF ELECTRICITY STORAGE MATERIAL IN ELECTRICITY STORAGE DEVICE

(71) Applicant: JTEKT CORPORATION, Osaka-shi (JP)

(72) Inventors: Koji NISHI, Anjo-shi (JP); Takashi MATSUURA, Konan-shi (JP); Yukihiro KOMATSUBARA, Chiryu-shi (JP)

(73) Assignee: JTEKT CORPORATION, Osaka-shi (JP)

(21) Appl. No.: 14/587,460

(22) Filed: Dec. 31, 2014

(30) Foreign Application Priority Data
Jan. 14, 2014 (JP) 2014-004407

(51) Int. Cl. G06T 7/00

(52) U.S. Cl. CPC G06T 7/0004

(57) ABSTRACT

A degree-of-dispersion inspecting apparatus accurately quantifies the degree of dispersion of particles of an electricity storage material based on in-plane uniformityand void size uniformity, which are obtained from an image of a coating film of the electricity storage material. The in-plane uniformity is a macroscopic value based on the ratio of voids between the particles in the electricity storage material, and the void size uniformity is a microscopic value based on values equivalent to the sizes of the voids between the particles in the electricity storage material. This allows the degree of dispersion of the particles of the electricity storage material to be accurately quantified even if the particles of the electricity storage material are in contact with each other or vary in size.

### INCORPORATION BY REFERENCE

The disclosure of Japanese Patent Application No. 2014-004407 filed on Jan. 14, 2014 including the specification, drawings and abstract, is incorporated herein by reference in its entirety.

### BACKGROUND OF THE INVENTION

1. Field of the Invention

The invention relates to apparatuses for inspecting the degree of dispersion of particles of an electricity storage material in an electricity storage device.

2. Description of the Related Art

In recent years, lithium ion secondary batteries have been used as electricity storage devices for hybrid vehicles, electric vehicles, etc. Electrodes of the lithium ion secondary batteries are manufactured by first kneading powder of an active material etc. and a solution of a thickener to produce slurry of an active material (electricity storage material), and then applying the slurry of the active material to a base material such as aluminum foil and drying the slurry. Battery performance of the lithium ion secondary batteries is greatly affected by the degree of dispersion of particles of the active material in the electrodes. It is desired to quantify the degree of dispersion of particles in order to accurately evaluate the battery performance.

For example, Japanese Patent No. 2925195 describes an apparatus that quantifies the degree of dispersion of particles. This apparatus obtains the position of the center of gravity of each particle from an image in which particles are present, divides the image into a plurality of regions by line segments each connecting adjacent ones of the positions of the center of gravity, and quantifies the degree of dispersion of particles from the area of each region. Japanese Patent Application Publication No. H09-257686 (JP H09-257686 A) describes that void distribution is measured by obtaining the areas or perimeters of voids between particles from an image in which particles are present. Japanese Patent No. 5271967 describes that the degree of dispersion is obtained by dividing a mean deviation of the distances between the centers of gravity of voids by the mean of the distances between the centers of gravity of the voids. Japanese Patent Application Publication No. 2013-89491 (JP 2013-89491 A) describes that battery performance can be improved when the difference between the volume of an active material and the volume of voids is equal to or larger than a prescribed value.

The apparatus described in Japanese Patent No. 2925195 is not applicable in the case where particles are in contact with each other or the case where particles vary in size, because this apparatus is based on the assumption that particles having a substantially uniform size are separated from each other. JP H09-257686 A, Japanese Patent No. 5271967, and JP 2013-89491 A do not specifically describe quantification of the degree of dispersion of particles.

### SUMMARY OF THE INVENTION

It is one of objects of the invention to provide a degree-of-dispersion inspecting apparatus capable of quantifying the degree of dispersion even when particles of an electricity storage material in an electricity storage device are in contact with each other or vary in size.

According to an aspect of the invention, a degree-of-dispersion inspecting apparatus that inspects a degree of dispersion of particles of an electricity storage material in an electricity storage device includes: an imaging device that images a portion of the electricity storage device in which the particles of the electricity storage material are present, and obtains image data; a binarizing device that binarizes the image data to produce binarized image data; an image dividing device that divides the binarized image data into a plurality of image regions; a void ratio computing device that obtains a ratio of voids between the particles in each of the plurality of image regions; an in-plane uniformity computing device that obtains in-plane uniformity of the voids based on the ratios of the voids; a void size equivalent value computing device that obtains values equivalent to sizes of the voids between the particles in the binarized image data; a void size uniformity computing device that obtains void size uniformity of the voids based on the values equivalent to the sizes of the voids; and a degree-of-dispersion quantifying device that quantifies the degree of dispersion of the particles based on the in-plane uniformity and the void size uniformity.

According to the above aspect, attention is directed to the in-plane uniformity as a macroscopic value based on the ratio of the voids in the electricity storage material, and the void size uniformity as a microscopic value based on the values equivalent to the sizes of the voids in the electricity storage material. This allows the degree of dispersion of the particles of the electricity storage material to be accurately quantified even if the particles of the electricity storage material are in contact with each other or vary in size.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a schematic configuration diagram showing a degree-of-dispersion inspecting apparatus that inspects the degree of dispersion of particles of an electricity storage material in an electricity storage device according to an embodiment of the invention;

FIG. 2 is a flowchart showing processing in the degree-of-dispersion inspecting apparatus according to the embodiment of the invention;

FIG. 3 is a diagram showing an image of a coating film, which is obtained from image data;

FIG. 4 is a diagram showing an image of the coating film, which is obtained from binarized image data;

FIG. 5 is a diagram showing image regions into which the image of the coating film, which is obtained from the binarized image data, is divided;

FIG. 6 is a diagram showing a scanning direction in the binarized image data when obtaining values equivalent to the sizes of voids.

FIG. 7 is a diagram showing a frequency distribution of the values equivalent to the sizes of the voids in the binarized image data; and

FIG. 8 is a diagram showing a correlation between the quantified degree of dispersion of the particles and the rate of decrease in capacity of a lithium ion secondary battery.

### DETAILED DESCRIPTION OF EMBODIMENTS

An embodiment of the invention will be described below with reference to the accompanying drawings. A degree-of-dispersion inspecting apparatus according to an embodiment of the invention is, e.g., an apparatus that inspects the degree of dispersion of particles of an electricity storage material in electrodes (positive and negative electrodes) of a lithium ion secondary battery as an electricity storage device. Electrodes of lithium ion secondary batteries are manufactured by applying slurry of an active material as an electricity storage material to a base material such as aluminum foil or copper foil and drying the slurry.

For positive electrodes, specific examples of the active material include lithium-nickel oxide etc. as an active material (solid component), N-methylpyrrolidone etc. as a solvent (liquid), acetylene black etc. as a conductive aid, and polyvinylidene fluoride etc. as a binder. For negative electrodes, specific examples of the active material include graphite etc. as an active material (solid component), water as a solvent (liquid), carboxymethyl cellulose etc. as a thickener, and SRB rubber, polyacrylic acid, etc. as a binder.

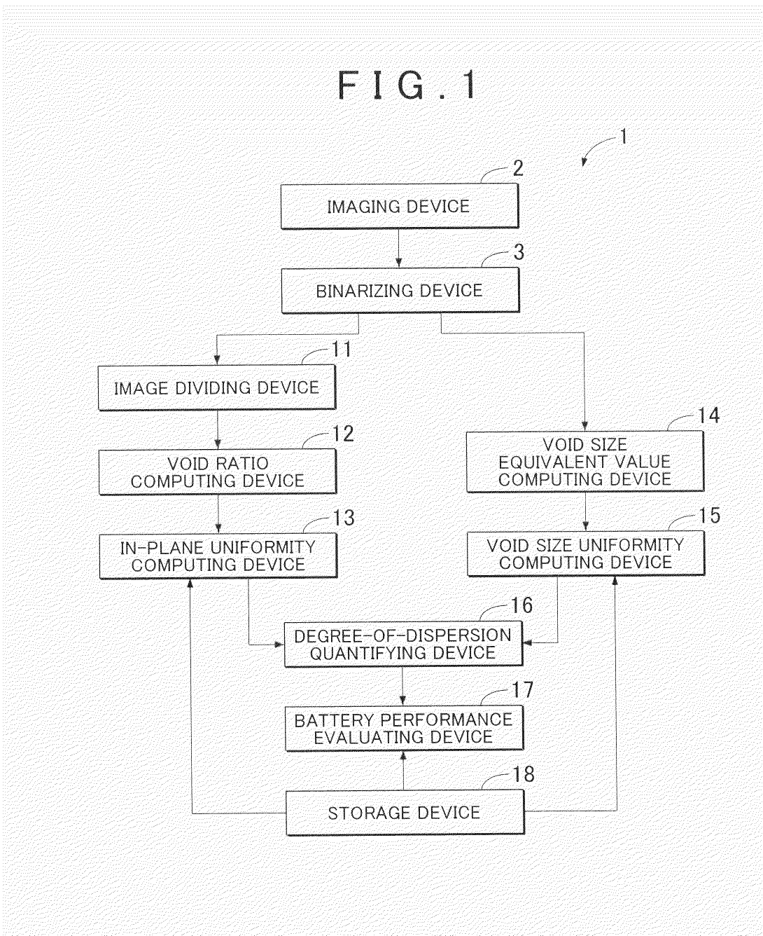

The configuration of the degree-of-dispersion inspecting apparatus according to the present embodiment will be described with reference to FIG. 1. A degree-of-dispersion inspecting apparatus 1 includes an imaging device 2, a binarizing device 3, an image dividing device 11, a void ratio computing device 12, an in-plane uniformity computing device 13, a void size equivalent value computing device 14, a void size uniformity computing device 15, a degree-of-dispersion quantifying device 16, a battery performance evaluating device 17, a storage device 18, etc.

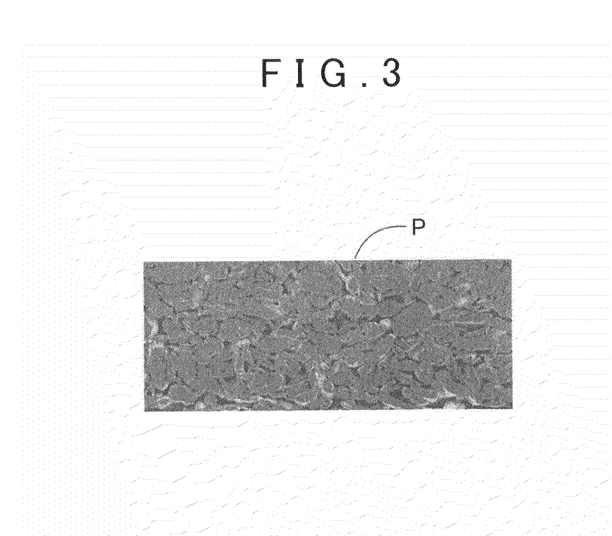

For example, a scanning electron microscope (SEM) etc. is used as the imaging device 2. In the present embodiment, the SEM irradiates and scans a coating film of the active material with an electron beam. The SEM sequentially shifts a linear scanning line of the electron beam to detect secondary electrons etc. discharged from the coating film, and obtains image data of the coating film from information on the coordinates irradiated with the electron beam and a detection signal of the secondary electrons etc. Examples of the electron beam scanning method include a method for scanning in one direction with an electron beam, a method for scanning in first direction and in second direction perpendicular to the first direction with an electron beam, etc. As shown in FIG. 3, an image P of a coating film, which is obtained from image data of the entire scanning region, is displayed on a display device of the imaging device 2.

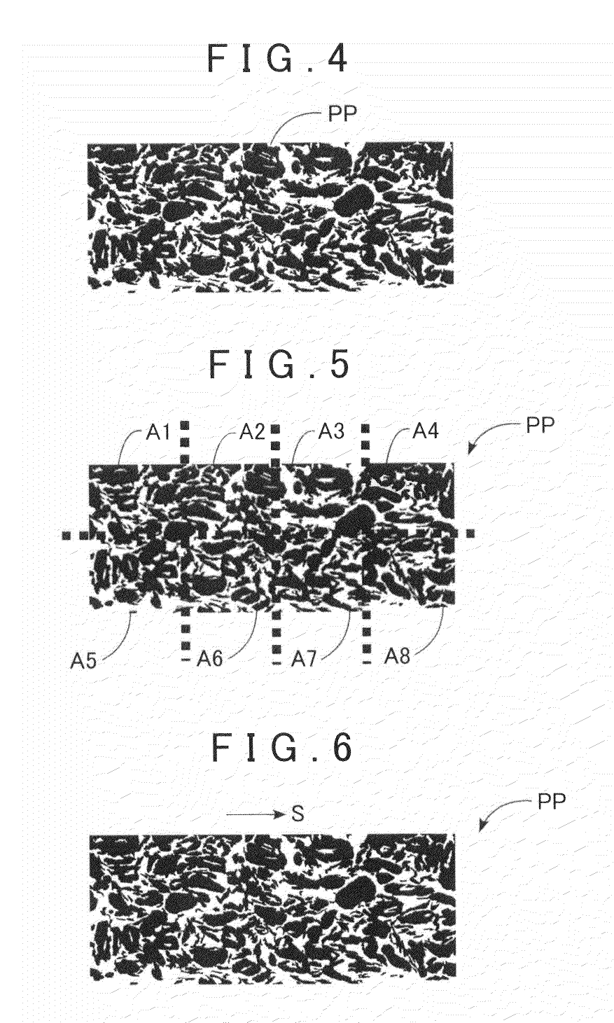

The binarizing device 3 performs binarization by dividing pixels of the image data of the entire scanning region, which is obtained by the imaging device 2, into black and white. The binarizing device 3 thus produces binarized image data. For example, as shown in FIG. 4, an image PP of the coating film, which is obtained from the binarized image data of the entire scanning region, is an image of 516 pixels by 1,276 pixels, and is formed by small black and white dots. Particles of the active material are represented in black, and voids are represented in white. The image dividing device 11 divides the binarized image data of the entire scanning region, which is produced by the binarizing device 3, into a plurality of image regions. For example, as shown in FIG. 5, the image PP of the coating film, which is obtained from the binarized image data of the entire scanning region, is divided into eight image regions A1 to A8.

The void ratio computing device 12 obtains the ratio of voids between particles in each of the image regions A1 to A8 obtained by the image dividing device 11. For example, the ratio of voids is the ratio of the area of the white parts in each image region A1 to A8 to the area of that image region A1 to A8. The area of each image region and the area of the white parts are obtained by the number of corresponding pixels. The in-plane uniformity computing device 13 obtains in-plane uniformity of the voids based on the ratios of voids in image regions A1 to A8, which is obtained by the void ratio computing device 12. As used herein, the term “in-plane uniformity” refers to variation in the ratio of voids among the plurality of image regions A1 to A8. A method for computing the in-plane uniformity will be described in detail later.

The void size equivalent value computing device 14 obtains values equivalent to the sizes of the voids between the particles in the binarized image data obtained by the binarizing device 3. For example, as shown in FIG. 6, the void size equivalent value computing device 14 obtains by the number of white pixels the lengths of the voids in the image PP of the coating film, which is obtained from the binarized image data of the entire scanning region, namely the lengths in the scanning direction of the white parts. Alternatively, the void size equivalent value computing device 14 obtains by the number of pixels the area of the voids in the image PP of the coating film, which is obtained from the binarized image data of the entire scanning region, namely the area of the white parts.

The void size uniformity computing device 15 obtains void size uniformity of the voids based on the lengths of the voids, which are obtained by the void size equivalent value computing device 14. As used herein, the term “void size uniformity” refers to variation in size among the voids in the binarized image data of the entire scanning region. A method for computing the void size uniformity will be described in detail later. The degree-of-dispersion quantifying device 16 quantifies the degree of dispersion of the particles based on the in-plane uniformity obtained by the in-plane uniformity computing device 13 and the void size uniformity obtained by the void size uniformity computing device 15. A method for computing the quantified degree of dispersion will be described in detail later.

The battery performance evaluating device 17 evaluates performance of the lithium ion secondary battery from the quantified degree of dispersion of the particles obtained in the degree-of-dispersion quantifying device 16, based on the correlation between the degree of dispersion of the particles of the active material in the electrodes of the lithium ion secondary battery, which has been obtained in advance, and the performance of the lithium ion secondary battery. A method for evaluating the performance will be described in detail later.

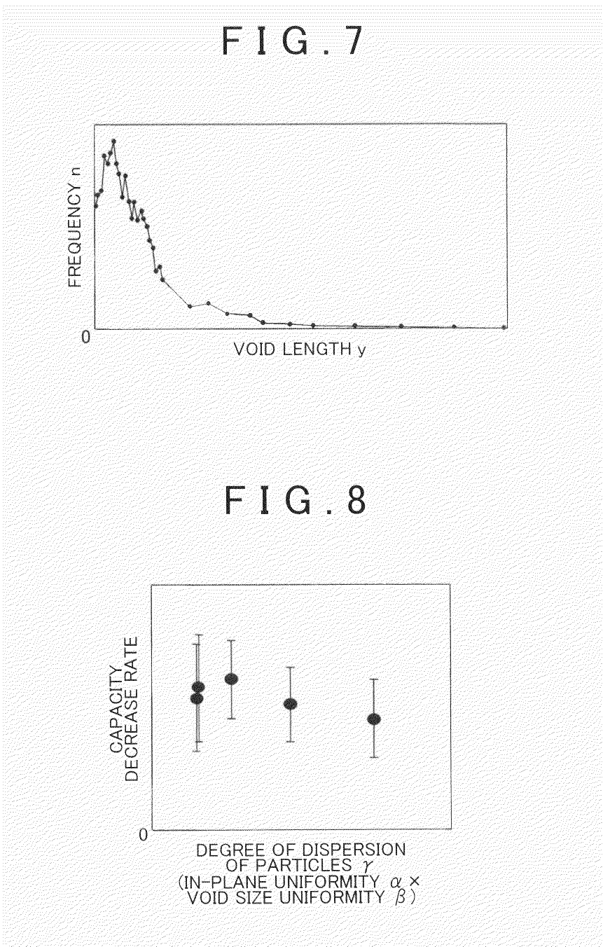

The storage device 18 has prestored therein expressions to be used in computation of the in-plane uniformity (expressions (1) to (3) described below), expressions to be used in computation of the void size uniformity (expressions (4) to (6) described below), an expression to be used in computation of the quantified degree of dispersion (expression (7) described below), and correlation data (see FIG. 8 etc.) between the degree of dispersion of the particles of the active material in the electrodes of the lithium ion secondary battery and the performance of the lithium ion secondary battery.

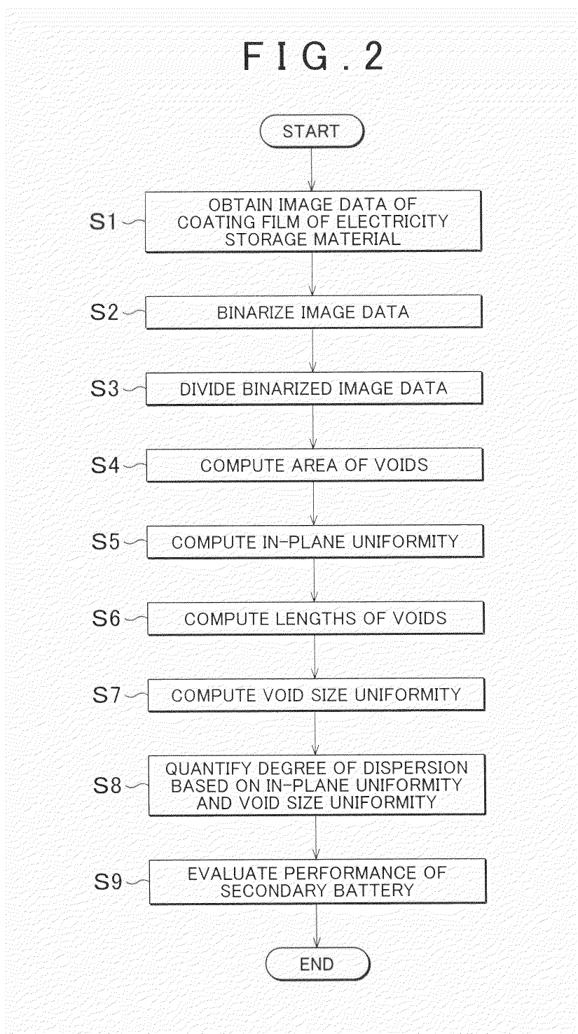

An inspection method that is used by the degree-of-dispersion inspecting apparatus 1 will be described below with reference to FIG. 2. First, as a preparatory step, a part of an electrode of a lithium ion secondary battery is cut out in the shape of a rectangular parallelepiped, and the surface of a coating film of an active material is polished with an argon ion beam. Next, as shown in FIG. 2, image data of the coating film of the active material is obtained (step S1). Specifically, a part of the electrode, which has the polished surface of the coating film, is placed in the imaging device 2, and such an image P of the coating film as shown in FIG. 3, which is obtained from the image data, is obtained.

Then, the image data is binarized (step S2 in FIG. 2), and the binarized image data is divided into a plurality of image regions (step S3). Specifically, the image dividing device 11 obtains such an image PP of the coating film as shown in FIG. 4, which is an image of 516 pixels by 1,276 pixels and is obtained from the black-and-white binarized image data (corresponding to step S2), and divides the image PP into a total of eight image regions A1 to A8 by equally dividing the image PP into four in the vertical direction and into two in the horizontal direction as shown in FIG. 5 (corresponding to step S3).

Thereafter, the area of voids in each image region will be obtained (step S4). Specifically, the void ratio computing device 12 obtains the number of pixels in the white parts in each image region A1 to A8 of 258 pixels by 319 pixels. Then, in-plane uniformity of the voids is obtained based on the area of the voids in each image region (step S5). Specifically, the in-plane uniformity computing device 13 obtains a void area ratio “xi” as a ratio of the area of the voids in each image region A1 to A8 to the area of that image region A1 to A8 (in this example, “i” is 1 to 8), and obtains an average value “ux” of the void area ratios “xi” in all of the image regions A1 to A8 by the following expression (1).

ux=Σᵢ₌₁⁸xi/8 (1)

The in-plane uniformity computing device 13 obtains a standard deviation value “dx” of the void area ratios “xi” in all of the image regions A1 to A8 by the following expression (2).

dx={square root over (((Σᵢ₌₁⁸(ux−xi)²)/8))} (2)

The in-plane uniformity computing device 13 obtains in-plane uniformity “α” of the voids in the binarized image data by substituting the average “ux” and the standard deviation “dx” of the void area ratios “xi” in all of the image regions A1 to A8 for the following expression (3).

α=ux/dx (3)

Then, the lengths of the voids in the binarized image data are obtained (step S6). Specifically, as shown in FIG. 6, the void size equivalent value computing device 14 obtains, by the number of pixels, the lengths in the scanning direction S of the white parts in the image PP of the coating film, the image PP which is obtained from the binarized image data. As shown in FIG. 7, a frequency distribution of the lengths of the voids in the image PP of the coating film, the image PP which is obtained from the binarized image data. The higher the degree of dispersion of the particles is, the higher the frequency of a specific length of the voids is.

Void size uniformity of the voids is obtained based on the lengths of the voids in the binarized image data (step S7). Specifically, the void size uniformity computing device 15 obtains an average value “uy” of the lengths of the voids by substituting the lengths “y” and frequencies “n” of all the voids for the following expression (4).

uy=Σ(y×n)/Σn (4)

The void size uniformity computing device 15 obtains a standard deviation “dy” of the lengths “y” of the voids by the following expression (5).

dy={square root over (((Σ(uy−y)²×n)/Σn))} (5)

The void size uniformity computing device 15 obtains void size uniformity “β” by substituting the average “uy” and the standard deviation “dy” of the lengths of the voids for the following expression (6). The void size uniformity β represents variation in size among the voids in the binarized image data.

β=(uy−dy)/uy (6)

Thereafter, as shown in FIG. 2, the degree of dispersion of the particles is quantified based on the in-plane uniformity and the void size uniformity (step S8). Specifically, the degree-of-dispersion quantifying device 16 obtains a value “y” from the in-plane uniformity α and the void size uniformity β(γ=α×β) as a quantified degree of dispersion of the particles, as given by the following expression (7).

γ=α×β (7)

Subsequently, performance of the lithium ion secondary battery is evaluated based on the value y of the quantified degree of dispersion of the particles (step S9), whereby all the processing is terminated. Specifically, the battery performance evaluating device 17 obtains the rate of decrease in capacity of the lithium ion secondary battery corresponding to the obtained value y of the quantified degree of dispersion of the particles, based on such a correlation between the value y of the degree of dispersion of the particles and the rate of decrease in capacity of the lithium ion secondary battery as shown in FIG. 8, and evaluates the performance of the lithium ion secondary battery. This correlation is prestored in the storage device 18.

The rate of decrease in capacity is represented by the number of times the lithium ion secondary battery has been charged and discharged until the time the charging capacity of the lithium ion secondary battery has decreased to, e.g., 60% from its initial charging capacity of 100% due to repeated charging and discharging. As shown in FIG. 8, the larger the value γ of the degree of dispersion of the particles is, the lower the rate of decrease in capacity and the variation in the rate of decrease in capacity are. Accordingly, the larger the value γ of the degree of dispersion of the particles is, the more satisfactory the battery performance is.

According to the degree-of-dispersion inspecting apparatus 1, attention is directed to the in-plane uniformity a as a macroscopic value based on the ratio of voids between the particles of the active material of the lithium ion secondary battery, and the void size uniformity β as a microscopic value based on the values equivalent to the sizes of the voids in the active material. This allows the degree of dispersion of the particles of the active material to be accurately quantified even if the particles of the active material are in contact with each other or vary in size. Moreover, the degree of dispersion of the particles of the active material is connected with the evaluation of the performance of the lithium ion secondary battery. This facilitates improvement in performance and functions of lithium ion secondary batteries, and can reduce the fraction defective of lithium ion secondary batteries. Because the lengths of the voids as values equivalent to the sizes of the voids in the active material are obtained by scanning in one scanning direction S, the lengths of the voids can be accurately obtained, which can increase accuracy of the quantified degree of dispersion of the particles of the electricity storage material.

In the above embodiment, the degree of dispersion of the particles of the active material is accurately quantified by using both the in-plane uniformity α based on the ratio of voids in the active material of the lithium ion secondary battery and the void size uniformity β based on the values equivalent to the sizes of the voids in the active material. In other embodiments, however, the degree of dispersion of the particles of the active material may be accurately quantified by using only one of the in-plane uniformity α or the void size uniformity β. In this case, the higher the in-plane uniformity α is, the higher the degree of dispersion of the particles of the active material is. In this case, the closer the void size uniformity β is to 1, the higher the degree of dispersion of the particles of the active material is.

In the above embodiment, the lengths of the voids of the active material are obtained by scanning in one direction. However, the lengths of the voids of the active material may be obtained by scanning in two directions, namely first direction and in second direction perpendicular to the first direction. Therefore, the lengths of the voids can thus be accurately obtained regardless of the shapes and directions of the voids, which can further increase accuracy of the quantified degree of dispersion of the particles of the electricity storage material. The invention is not limited to the apparatus that inspects the degree of dispersion of the particles of the active material for the electrodes of the lithium ion secondary battery. The invention is also applicable to apparatuses that inspect the degree of dispersion of particles of any electricity storage material such as a material of a capacitor.

The void area ratio “xi” that is calculated by the in-plane uniformity computing device 13 may be the ratio of the area of each image region A1 to A8 to the area of voids in that image region A1 to A8. The ratio of voids between the particles in each image region A1 to A8 may be replaced with the ratio of the area of the black parts in each image region A1 to A8 to the area of that image region A1 to A8.

What is claimed is:

1. A degree-of-dispersion inspecting apparatus that inspects a degree of dispersion of particles of an electricity storage material in an electricity storage device, comprising:
an imaging device that images a portion of the electricity storage device in which the particles of the electricity storage material are present, and obtains image data;
a binarizing device that binarizes the image data to produce binarized image data;
an image dividing device that divides the binarized image data into a plurality of image regions;
a void ratio computing device that obtains a ratio of voids between the particles in each of the plurality of image regions;
an in-plane uniformity computing device that obtains in-plane uniformity of the voids based on the ratios of the voids;
a void size equivalent value computing device that obtains values equivalent to sizes of the voids between the particles in the binarized image data;
a void size uniformity computing device that obtains void size uniformity of the voids based on the values equivalent to the sizes of the voids; and
a degree-of-dispersion quantifying device that quantifies the degree of dispersion of the particles based on the in-plane uniformity and the void size uniformity.

2. The degree-of-dispersion inspecting apparatus according to claim 1, wherein,
the imaging device obtains the image data by scanning in a prescribed direction, and
the void size equivalent value computing device obtains lengths of the voids between the particles in the binarized image data as the values equivalent to the sizes of the voids.

3. The degree-of-dispersion inspecting apparatus according to claim 2, wherein, the imaging device obtains the image data by scanning in one direction.

4. The degree-of-dispersion inspecting apparatus according to claim 2, wherein,
the imaging device obtains the image data by scanning in first direction and in second direction perpendicular to the first direction.

5. The degree-of-dispersion inspecting apparatus according to claim 1, further comprising:
a storage device in which a correlation between the quantified degree of dispersion of the particles and performance of the electricity storage device is prestored; and,
a performance evaluating device that evaluates, based on the correlation, the performance of the electricity storage device from the quantified degree of dispersion of the particles obtained by the degree-of-dispersion quantifying device.

6. The degree-of-dispersion inspecting apparatus according to claim 2, further comprising:
a storage device in which a correlation between the quantified degree of dispersion of the particles and performance of the electricity storage device is prestored; and,
a performance evaluating device that evaluates, based on the correlation, the performance of the electricity storage device from the quantified degree of dispersion of the particles obtained by the degree-of-dispersion quantifying device.

7. The degree-of-dispersion inspecting apparatus according to claims 3, further comprising:
a storage device in which a correlation between the quantified degree of dispersion of the particles and performance of the electricity storage device is prestored; and,
a performance evaluating device that evaluates, based on the correlation, the performance of the electricity storage device from the quantified degree of dispersion of the particles obtained by the degree-of-dispersion quantifying device.

8. The degree-of-dispersion inspecting apparatus according to claim 4, further comprising:
a storage device in which a correlation between the quantified degree of dispersion of the particles and performance of the electricity storage device is prestored; and,
a performance evaluating device that evaluates, based on the correlation, the performance of the electricity storage device from the quantified degree of dispersion of the particles obtained by the degree-of-dispersion quantifying device.

9. A degree-of-dispersion inspecting apparatus that inspects a degree of dispersion of particles of an electricity storage material in an electricity storage device, comprising:
an imaging device that images a portion of the electricity storage device in which the particles of the electricity storage material are present, and obtains image data;
a binarizing device that binarizes the image data to produce binarized image data;
an image dividing device that divides the binarized image data into a plurality of image regions;
a void ratio computing device that obtains a ratio of voids between the particles in each of the plurality of image regions;
an in-plane uniformity computing device that obtains in-plane uniformity of the voids based on the ratios of the voids; and
a degree-of-dispersion quantifying device that quantifies the degree of dispersion of the particles based on the in-plane uniformity.

10. A degree-of-dispersion inspecting apparatus that inspects a degree of dispersion of particles of an electricity storage material in an electricity storage device, comprising:
an imaging device that images a portion of the electricity storage device in which the particles of the electricity storage material are present, and obtains image data;
a binarizing device that binarizes the image data to produce binarized image data;
a void size equivalent value computing device that obtains values equivalent to sizes of the voids between the particles in the binarized image data;
a void size uniformity computing device that obtains void size uniformity of the voids based on the values equivalent to the sizes of the voids; and
a degree-of-dispersion quantifying device that quantifies the degree of dispersion of the particles based on the void size uniformity.

11. The degree-of-dispersion inspecting apparatus according to claim 1, wherein, the particles of the electricity storage material are particles of an active material, and the imaging device is a scanning electron microscope (SEM).

12. The degree-of-dispersion inspecting apparatus according to claim 6, wherein, the particles of the electricity storage material are particles of an active material, and the imaging device is a scanning electron microscope (SEM).

13. The degree-of-dispersion inspecting apparatus according to claim 7, wherein, the particles of the electricity storage material are particles of an active material, and the imaging device is a scanning electron microscope (SEM).
